(19) United States
(12) Patent Application Publication
(10) Pub. No.: US 2006/0054337 A1
(43) Pub. Date: Mar. 16, 2006

(54) Electronic apparatus with symmetrically-opened cover for protecting image capture device

(75) Inventor: Yung-Tsun Hsieh, Changhua (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/219,702

(22) Filed: Sep. 7, 2005

(30) Foreign Application Priority Data
Sep. 8, 2004 (TW) 93127107

(51) Int. Cl. H02G 3/08

(52) U.S. Cl. 174/50

(57) ABSTRACT

An electronic apparatus with a symmetrically-opened cover for protecting an image capture device. The electronic apparatus includes a body, a cover, and an opening device. The image capture device and the opening device are disposed on the body. The cover is connected to the opening device, and includes a first portion and a second portion. The first portion and the second portion are symmetrically moved between a first position and a second position by the opening device. When the first portion and the second portion are in the first position, the image capture device is covered by the cover. When the first portion and the second portion are in the second position, the image capture device is exposed by the opened cover.

### BACKGROUND

The invention relates to electronic apparatuses, and in particular, to electronic apparatuses with a symmetrically-opened cover for protecting an image capture device thereof.

Recently, many handheld electronic apparatuses, such as mobile phones, comprise image capture devices therein. Since the handheld electronic apparatus is often placed in a pocket or purse for easy transport, an exposed lens of the image capture device is easily damaged.

### SUMMARY

An electronic apparatus is provided. An exemplary embodiment of an electronic apparatus comprises a body, an opening device, and a cover. The body comprises an image capture device. The opening device is disposed on the body. The cover is connected to the opening device, and comprises a first portion and a second portion. The first portion and the second portion are symmetrically moved between a first position and a second position by the opening device. When the first portion and the second portion are in the first position, the image capture device is covered by the cover. When the first portion and the second portion are in the second position, the image capture device is exposed by the cover.

Furthermore, the opening device comprises a base and a moving assembly. The base is disposed on the body. The moving assembly is connected to the cover, and is disposed on the base to be moveable with respect to the base. The moving assembly comprises a first slide, a second slide, a first shaft, and a second shaft. The first slide is connected to the first portion, and is moveably disposed on the base. The second slide is connected to the second portion, and is moveably disposed on the base. The first shaft is moveably disposed in the first slide. The second shaft is moveably disposed in the second slide. The base comprises a first groove. The first slide comprises a first rail. The second slide comprises a second rail. The first and second slides are rotated on the base by the first and second rails moving along the first groove.

Additionally, the first slide comprises a first hole in which the first shaft is disposed. The second slide comprises a second hole in which the second shaft is disposed. The opening device further comprises a fixed assembly to combine the first and second shafts and the base. The base comprises a second groove. The first shaft comprises a first through hole. The second shaft comprises a second through hole. The fixed assembly comprises a pin and a C-shaped ring. The pin passes through the second through hole, the first through hole, and the second groove. The C-shaped ring is combined with the pin so that the first and second shafts are moveable along the second groove by the pin. The pin comprises a concave portion in which the C-shaped ring is disposed.

Moreover, the first slide comprises a first screw hole. The second slide comprises a second screw hole. The first portion comprises a through hole corresponding to the first screw hole. The second portion comprises a through hole corresponding to the second screw hole. The electronic apparatus further comprises a first screw and a second screw. The first slide is combined with the first portion by the first screw entering the first screw hole via the through hole of the first portion. The second slide is combined with the second portion by the second screw entering the second screw hole via the through hole of the second portion. The base comprises a through hole. The body comprises a screw hole corresponding to the through hole of the base. The electronic apparatus further comprises a screw entering the screw hole of the body via the through hole of the base so that the base is combined with the body.

Note that the electronic apparatus may be a mobile phone.

### DESCRIPTION OF THE DRAWINGS

The invention can be more fully understood by reading the subsequent detailed description and examples with references made to the accompanying drawings, wherein:

FIG. 1a is an exploded view of an embodiment of an electronic apparatus;

FIG. 1b is a schematic view of the assembled electronic apparatus in FIG. 1a, wherein a cover is in a first position;

FIG. 1c is a schematic view of the assembled electronic apparatus in FIG. 1a, wherein the cover is in a second position;

FIG. 1d is an exploded view of a body and an opening device;

FIG. 2a is an exploded view of the opening device;

FIG. 2b is a schematic view of a base in FIG. 2a;

FIG. 2c is a schematic view of a first slide in FIG. 2a;

FIG. 2d is a schematic view of a second slide in FIG. 2a;

FIG. 3a is a schematic view of the assembled opening device in FIG. 2a, wherein a moving assembly is in the first position; and

FIG. 3b is a schematic view of the assembled opening device in FIG. 2a, wherein the moving assembly is in the second position.

### DETAILED DESCRIPTION

An embodiment of an electronic apparatus comprises a cover to protect an image capture device. When the image capture device is in an operational state, it is exposed by opening the cover. When the image capture device is idle, it is covered by the cover to prevent damage or contamination by environmental detritus. Additionally, in view of convenience, when one portion of the cover is manually opened, another portion of the cover must be automatically opened so that the image capture device is always located at a center of the cover. Moreover, an axis of an opening device for opening the cover must be located under a predetermined axial line, thus preventing different portions of the cover from interfering with each other. An embodiment of the electronic apparatus is designed based on the preceding requirements, and is described in detail in the following.

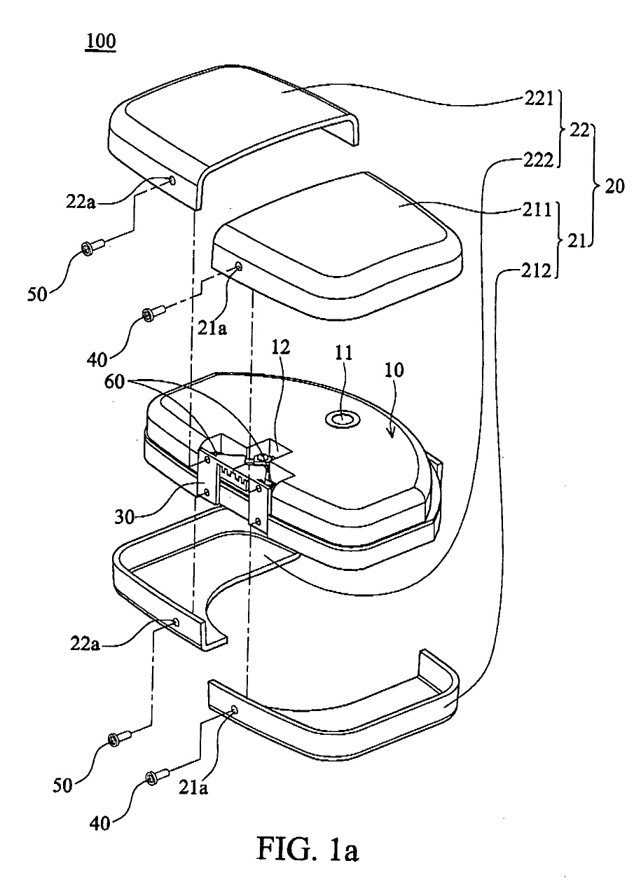

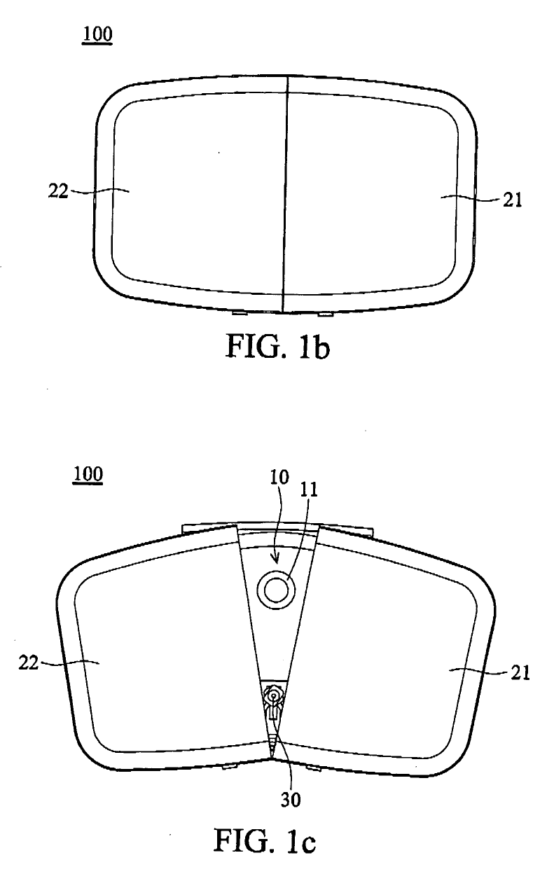

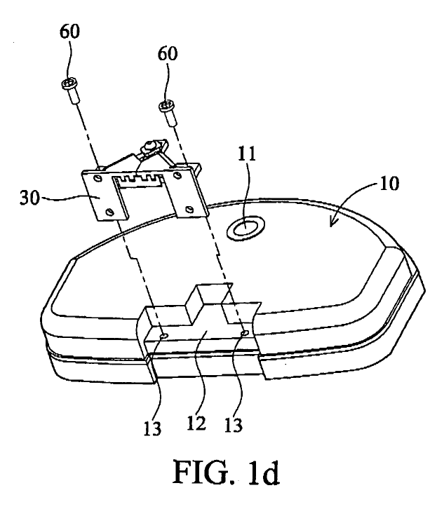

FIGS. 1a, 1b and 1c depict an embodiment of an electronic apparatus 100 comprising a body 10, a cover 20, an opening device 30, two first screws 40, two second screws 50, and two third screws 60. The body 10 is a main portion of the electronic apparatus 100, and comprises required devices therein. As shown in FIG. 1d, the body 10 comprises an image capture device 11 and a concave portion 12 on the same surface. Two third screw holes 13 are formed in the concave portion 12.

The cover 20 comprises a first portion 21 and a second portion 22. The first portion 21 comprises a first lower case 211 and a first upper case 212. The second portion 22 comprises a second lower case 221 and a second upper case 222. The cover 20 is connected to the opening device 30 to be disposed on the body 10. Third through holes 21a are formed on the first lower case 211 and the first upper case 212 respectively. Fourth through holes 22a are formed on the second lower case 221 and the second upper case 222 respectively.

The opening device 30 is disposed in the concave portion 12 of the body 10, and is connected to the cover 20 so that the first portion 21 and the second portion 22 are symmetrically moved between a closed position (shown in FIG. 1b and hereinafter referred to as a first position) and an open position (shown in FIG. 1c and hereinafter referred to as a second position). When the cover 20 is in the first position, the image capture device 11 is covered by the cover 20. When the cover 20 is in the second position, the image capture device 11 is exposed by opening the cover 20.

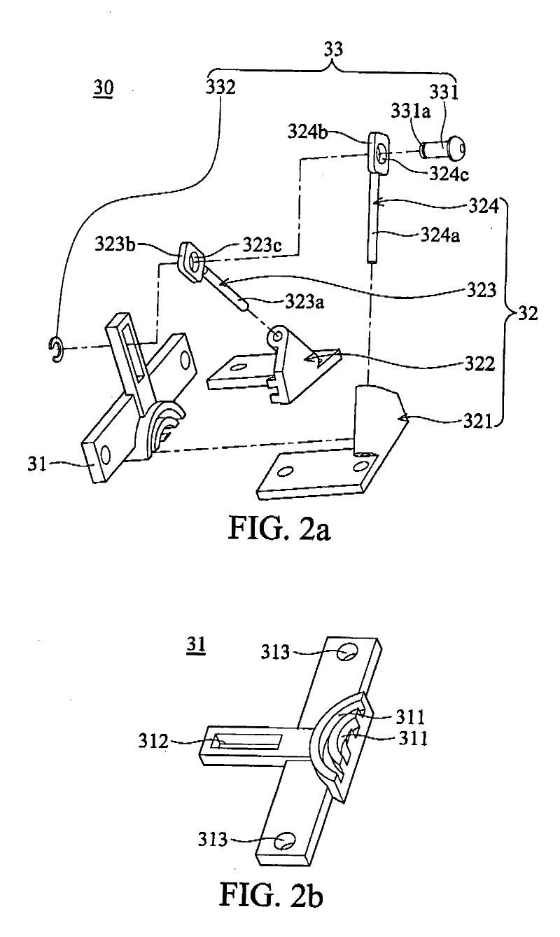

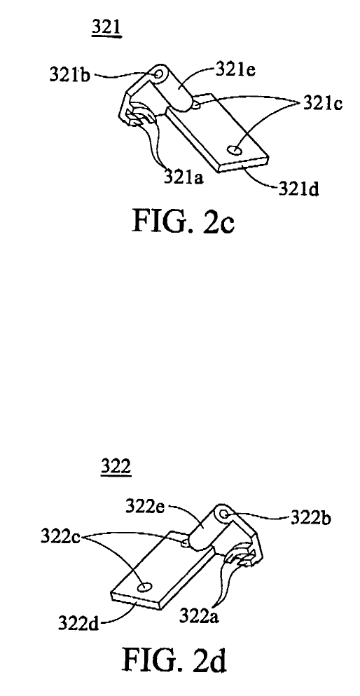

Referring to FIG. 2a, the opening device 30 comprises a base 31, a moving assembly 32, and a fixed assembly 33. As shown in FIG. 2b, the base 31 comprises two first grooves 311, a second groove 312, and two fifth through holes 313. Each first groove 311 is formed at the center of the base 31 in a cylindrical shape. The second groove 312 is formed at an extension portion of the base 31 in a rectangular shape. Each fifth through hole 313 is formed in each side of the base 31 to correspond to the third screw hole 13 of the body 10. Each third screw 60 is screwed into the third screw hole 13 via the fifth through hole 313 so that the base 31 is combined with the body 10.

The moving assembly 32 is connected to the cover 20, and is disposed on the base 31 to be moveable with respect to the base 31. Referring to FIG. 2a, the moving assembly 32 comprises a first slide 321, a second slide 322, a first shaft 323, and a second shaft 324.

The first slide 321 is connected to the first portion 21, and is rotatably disposed on the base 31. Referring to FIG. 2c, the first slide 321 is divided into a main portion 321d and an extension portion 321e. The first slide 321 comprises first screw holes 321 at both sides of the main portion 321d to correspond to the third through holes 21a of the first portion 21. Each first screw 40 is screwed into the first screw hole 321c via the third through hole 21a so that the first slide 321 is combined with the first portion 21. Furthermore, the first slide 321 comprises two first rails 321a and a first hole 321b at the extension portion 321e. When the first slide 321 is combined with the base 31, the first rails 321a are fit into the first grooves 311 so that the first slide 321 is rotatable on the base 31.

The second slide 322 is connected to the second portion 22, and is rotatably disposed on the base 31. Referring to FIG. 2d, the second slide 322 is divided into a main portion 322d and an extension portion 322e. The second slide 322 comprises second screw holes 322c in each side of the main portion 322d corresponding to the fourth through holes 22a of the second portion 22. Each second screw 50 is screwed into the second screw hole 322c via the fourth through hole 22a so that the second slide 322 is combined with the second portion 22. Furthermore, the second slide 322 comprises two second rails 322a and a second hole 322b in the extension portion 322e. When the second slide 322 is combined with the base 31, the second rails 322a are fit into the first grooves 311 so that the second slide 322 is rotatable on the base 31.

The first shaft 323 is moveably disposed in the first slide 321. Referring to FIG. 2a, the first shaft 323 is divided into a rod portion 323a and a stem portion 323b. The rod portion 323a is placed in the first hole 321b of the first slide 321. The first shaft 323 further comprises a first through hole 323c at the stem portion 323b.

The second shaft 324 is moveably disposed in the second slide 322. Referring to FIG. 2a, the second shaft 324 is divided into a rod portion 324a and a stem portion 324b. The rod portion 324a is placed in the second hole 322b of the second slide 322. The second shaft 324 further comprises a second through hole 324c at the stem portion 324b.

The fixed assembly 33 combines the first and second shafts 323 and 324 and the base 31. As shown in FIG. 2a, the fixed assembly 33 comprises a pin 331 and a C-shaped ring 332. The pin 331 comprises a concave portion 331a, and passes through the second through hole 324c of the second shaft 324, the first through hole 323c of the first shaft 323, and the second groove 312 of the base 31. The C-shaped ring 332 is located in the concave portion 331a of the pin 331 so that the first and second shafts 323 and 324 are moveable along the second groove 312 by the pin 331.

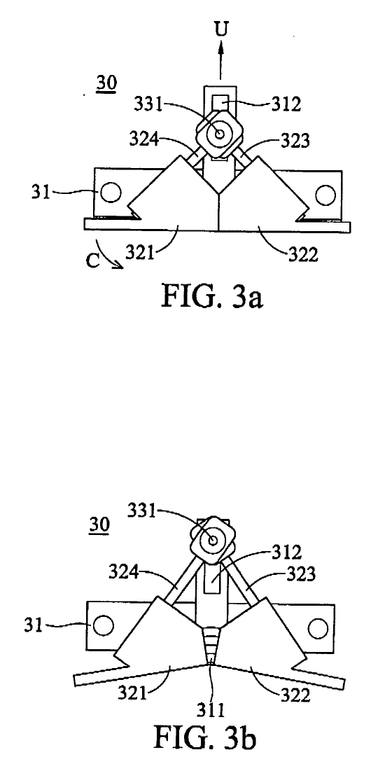

FIGS. 3a and 3b depict the motion of the opening device 30. When the pin 331 is moved in a direction, shown by arrow U in FIG. 3a, along the second groove 312 of the base 31, the first and second shafts 323 and 324 are moved correspondingly. Since the first and second shafts 323 and 324 can move with respect to the first and second slides 321 and 322 respectively, the first and second slides 321 and 322 are rotated when the first and second shafts 323 and 324 are moved. Thus, the distance, protruding from the first and second holes 321b and 322b, of the first and second shafts 323 and 324 are increased.

Additionally, when the first slide 321 is rotated with respect to the base 31 in a direction shown by arrow C in FIG. 3a, the distance, protruding from the second hole 322b, of the second shaft 324 is increased. Thus, the pin 331 is moved in the second groove 312. At the same time, the first slide 321 is rotated by the pin 331.

As previously described, when one slide is rotated with respect to the base, another slide is rotated in a reverse direction simultaneously. Moreover, as the rotation routes of the first and second slides are along the same groove, another rotary shaft is not required. Additionally, the rotational center of the first and second slides need not on the opening device.

To use the image capture device 11, the first portion 21 is opened. At this time, the second slide 322 is moved by the first slide 321 connected to the first portion 21, and the second portion 22, connected to the second slide 322, is opened simultaneously. Similarly, when the second portion 22 is opened, the first slide 321 is moved by the second slide 322 connected to the second portion 22. Thus, the first portion 21, connected to the first slide 321, is opened simultaneously.

Additionally, since the rotational center of the first and second slides 321 and 322 need not on the opening device 30, the first and second portions 21 and 22, fixed to the first and second slides 321 and 322 respectively, do not pass through the rotational center of the opening device 30. Thus, the first and second portions 21 and 22 will not interfere with each other during rotation.

Note that the electronic apparatus may be a mobile phone.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus comprising:
a body comprising an image capture device;
an opening device disposed on the body; and
a cover, connected to the opening device, comprising a first portion and a second portion, wherein the first portion and the second portion are symmetrically moved between a first position and a second position by the opening device, the image capture device is covered by the cover when the first portion and the second portion are in the first position, and the image capture device is exposed by the cover when the first portion and the second portion are in the second position.

2. The electronic apparatus as claimed in claim 1, wherein the opening device comprises:
a base disposed on the body; and
a moving assembly, connecting to the cover, disposed on the base to be moveable with respect to the base.

3. The electronic apparatus as claimed in claim 2, wherein the moving assembly comprises:
a first slide, connecting to the first portion, moveably disposed on the base;
a second slide, connecting to the second portion, moveably disposed on the base;
a first shaft moveably disposed in the first slide; and
a second shaft moveably disposed in the second slide.

4. The electronic apparatus as claimed in claim 3, wherein the base comprises a first groove, the first slide comprises a first rail, the second slide comprises a second rail, and the first and second slides are rotated on the base by the first and second rails moving along the first groove.

5. The electronic apparatus as claimed in claim 3, wherein the first slide comprises a first hole in which the first shaft is disposed, and the second slide comprises a second hole in which the second shaft is disposed.

6. The electronic apparatus as claimed in claim 3, wherein the opening device further comprises a fixed assembly to combine the first and second shafts and the base.

7. The electronic apparatus as claimed in claim 6, wherein the base comprises a second groove, the first shaft comprises a first through hole, the second shaft comprises a second through hole, and the fixed assembly comprises:
a pin passing through the second through hole, the first through hole, and the second groove; and
a C-shaped ring combined with the pin so that the first and second shafts are moveable along the second groove by the pin.

8. The electronic apparatus as claimed in claim 7, wherein the pin comprises a concave portion in which the C-shaped ring is disposed.

9. The electronic apparatus as claimed in claim 3, wherein the first slide comprises a first screw hole, the second slide comprises a second screw hole, the first portion comprises a through hole corresponding to the first screw hole, the second portion comprises a through hole corresponding to the second screw hole, the electronic apparatus further comprises a first screw and a second screw, the first slide is combined with the first portion by the first screw entering the first screw hole via the through hole of the first portion, and the second slide is combined with the second portion by the second screw entering the second screw hole via the through hole of the second portion.

10. The electronic apparatus as claimed in claim 2, wherein the base comprises a through hole, the body comprises a screw hole corresponding to the through hole, and the electronic apparatus further comprises a screw entering the screw hole via the through hole so that the base is combined with the body.

11. The electronic apparatus as claimed in claim 1, wherein the electronic apparatus is a mobile phone.
